(19) United States
(12) Patent Application Publication
(10) Pub. No.: US 2002/0168066 A1
(43) Pub. Date: Nov. 14, 2002

(54) Video encoding and decoding techniques and apparatus

(76) Inventor: Weiping Li, Palo Alto, CA (US)

Correspondence Address: Martin Novack, 17414 Via Capri East, Boca Raton, FL, 33496, US

(21) Appl. No.: 10/055,803

(22) Filed: Jan. 22, 2002

Related U.S. Application Data
(60) Provisional application No. 60/263,245, filed on Jan. 22, 2001.

(51) Int. Cl. H04N 7/167

(52) U.S. Cl. 380/200

(57) ABSTRACT

For use in conjunction with a video encoding/decoding technique wherein images are encoded using truncatable image-representable signals in bit plane form, a method including the following steps: selecting a number of bitplanes to be used in a prediction loop; and producing an alignment parameter in a syntax portion of an encoded bitstream that determines the alignment of bitplanes with respect to the prediction loop.

### RELATED APPLICATION

This application claims priority from U.S. Provisional Patent Application No. 60/263,245, filed Jan. 22, 2001, and said Provisional Patent Application is incorporated herein by reference.

### FIELD OF THE INVENTION

This invention relates to encoding and decoding of video signals, and, more particularly, to a method and apparatus for improved encoding and decoding of scalable bitstreams used for streaming encoded video signals.

### BACKGROUND OF THE INVENTION

In many applications of digital video over a variable bitrate channel such as the Internet, it is very desirable to have a video coding technique with fine granularity scalability (FGS). Using FGS, the content producer can encode a video sequence into a base layer that is the minimum bitrate for the channel and an enhancement layer to cover the maximum bitrate for the channel. FGS enhancement layer bitstream can be truncated at any bitrate and the video quality of the truncated bitstream is proportional to the number of bits in the enhancement layer. FGS is also a very desirable functionality for video distribution. Different local channels may take an appropriate amount of bits from the same FGS bitstream to meet different channel distribution requirements.

For such purposes an FGS technique is defined in MPEG-4. The current FGS technique in MPEG-4 uses an open-loop enhancement structure. This helps minimize drift; i.e., if the enhancement information is not received for the previous frame, it does not affect the quality of the current frame. However, the open-loop enhancement structure is not as efficient as the closed-loop structure because the enhancement information for the previous frame, if received, does not enhance the quality of the current frame.

It is among the objects of the present invention to devise a technique and apparatus that will address this limitation of prior art approaches and achieve improvement of fine granularity scaling operation.

### SUMMARY OF THE INVENTION

An approach hereof is to include a certain amount of enhancement layer information into the prediction loop so that coding efficiency can be improved while minimizing drift. A form of the present invention involves a technique for implementing partial enhancement information in the prediction loop.

A form of the invention has application for use in conjunction with a video encoding/decoding technique wherein images are encoded using truncatable image-representable signals in bit plane form. The method comprises the following steps: selecting a number of bitplanes to be used in a prediction loop; and producing an alignment parameter in a syntax portion of an encoded bitstream that determines the alignment of bitplanes with respect to the prediction loop. An embodiment of this form of the invention further comprises providing a decoder for decoding the encoded bitstream, the decoder being operative in response to the alignment parameter to align decoded bit planes with respect to a prediction loop.

A further form of the invention has application for use in conjunction with a video encoding/decoding technique wherein image frames of macroblocks are encoded using truncatable image-representable signals in bit plane form, and subsequently decoded with a decoder. The method comprising the following steps: selecting a number of bitplanes to be used in a prediction loop; and producing an encoded bitstream for each frame that includes an alignment parameter which determines the alignment of bitplanes with respect to the prediction loop.

Further features and advantages of the invention will become more readily apparent from the following detailed description when taken in conjunction with the accompanying drawings.

### BRIEF DESCRIPTION OF THE DRAWINGS

FIG. 1 is a block diagram of a type of apparatus which can be used in practicing embodiments of the invention.

FIG. 2 is block diagram of an embodiment of an encoder employing scalable coding technology.

FIG. 3 is a block diagram of an embodiment of a decoder employing scalable coding technology.

FIG. 4 is a diagram illustrating least significant bit (LSB) alignment of bitplanes.

FIG. 5 is a diagram illustrating most significant bit (MSB) alignment of bitplanes.

FIG. 6 is a table showing syntax elements for a frame header in accordance with an embodiment of the invention.

FIG. 7 is a table defining the meaning of the alignment parameter in accordance with an embodiment of the invention.

FIG. 8 is a diagram illustrating an example of variable alignment of bit planes with respect to a prediction loop in accordance with an embodiment of the invention.

FIG. 9, which includes FIGS. 9A and 9B placed one below another, is a flow diagram of a routine for programming the encoder processor in accordance with an embodiment of the invention.

FIG. 10, which includes FIGS. 10A and 10B placed one below another, is a flow diagram of a routine for programming the decoder processor in accordance with an embodiment of the invention.

### DETAILED DESCRIPTION

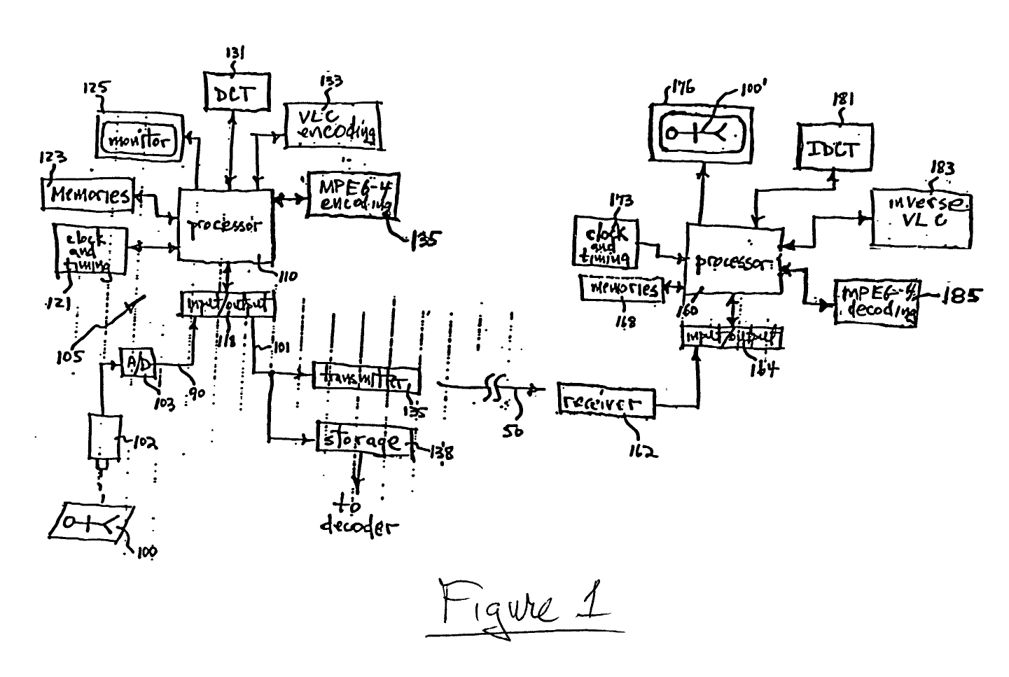

Referring to FIG. 1, there is shown a block diagram of an apparatus, at least parts of which can be used in practicing embodiments of the invention. A video camera 102, or other source of video signal, produces an array of pixel-representative signals that are coupled to an analog-to-digital converter 103, which is, in turn, coupled to the processor 110 of an encoder 105. When programmed in the manner to be described, the processor 110 and its associated circuits can be used to implement embodiments of the invention. The processor 110 may be any suitable processor, for example an electronic digital processor or microprocessor. It will be understood that any general purpose or special purpose processor, or other machine or circuitry that can perform the functions described herein, electronically, optically, or by other means, can be utilized. The processor 110, which for purposes of the particular described embodiments hereof can be considered as the processor or CPU of a general purpose electronic digital computer, will typically include memories 123, clock and timing circuitry 121, input/output functions 118 and monitor 125, which may all be of conventional types. In the present embodiment blocks 131, 133, and 135 represent functions that can be implemented in hardware, software, or a combination thereof for implementing coding of the type employed for MPEG-4 video encoding. The block 131 represents a discrete cosine transform function that can be implemented, for example, using commercially available DCT chips or combinations of such chips with known software, the block 133 represents a variable length coding (VLC) encoding function, and the block 135 represents other known MPEG-4 encoding modules, it being understood that only those known functions needed in describing and implementing the invention are treated in describing and implementing the invention are treated herein in any detail.

With the processor appropriately programmed, as described hereinbelow, an encoded output signal 101 is produced which can be a compressed version of the input signal 90 and requires less bandwidth and/or less memory for storage. In the illustration of FIG. 1, the encoded signal 101 is shown as being coupled to a transmitter 135 for transmission over a communications medium (e.g. air, cable, network, fiber optical link, microwave link, etc.) 50 to a receiver 162. The encoded signal is also illustrated as being coupled to a storage medium 138, which may alternatively be associated with or part of the processor subsystem 110, and which has an output that can be decoded using the decoder to be described.

Coupled with the receiver 162 is a decoder 155 that includes a similar processor 160 (which will preferably be a microprocessor in decoder equipment) and associated peripherals and circuits of similar type to those described in the encoder. These include input/output circuitry 164, memories 168, clock and timing circuitry 173, and a monitor 176 that can display decoded video 100′. Also provided are blocks 181, 183, and 185 that represent functions which (like their counterparts 131, 133, and 135 in the encoder) can be implemented in hardware, software, or a combination thereof. The block 181 represents an inverse discrete cosine transform function, the block 183 represents an inverse variable length coding function, and the block 185 represents other MPFG-4 decoding functions.

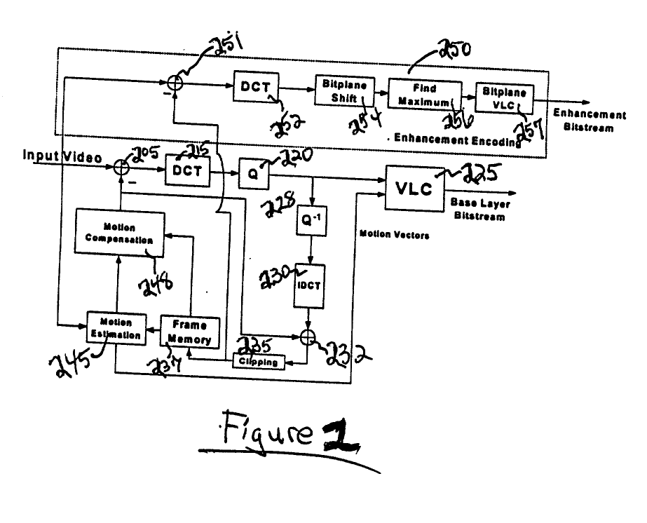

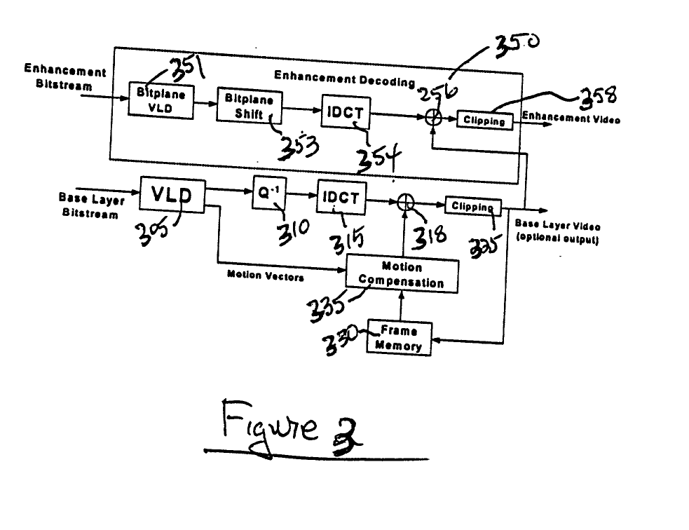

MPFG-4 scalable coding technology employs bitplane coding of discrete cosine transform (DCT) coefficients. FIGS. 2 and 3 show, respectively, encoder and decoder structures employing scalable coding technology. The lower parts of FIGS. 2 and 3 show the base layer and the upper parts in the dotted boxes 250 and 350, respectively, show the enhancement layer. In the base layer, motion compensated DCT coding is used.

In FIG. 2, input video is one input to combiner 205, the output of which is coupled to DCT encoder 215 and then to quantizer 220. The output of quantizer 220 is one input to variable length coder 225. The output of quantizer 220 is also coupled to inverse quantizer 228 and then inverse DCT 230. The IDCT output is one input to combiner 232, the output of which is coupled to clipping circuit 235. The output of the clipping circuit is coupled to a frame memory 237, whose output is, in turn, coupled to both a motion estimation circuit 245 and a motion compensation circuit 248. The output of motion compensation circuit 248 is coupled to negative input of combiner 205 (which serves as a difference circuit) and also to the other input to combiner 232. The motion estimation circuit 245 receives, as its other input, the input video, and also provides its output to the variable length coder 225. In operation, motion estimation is applied to find the motion vector(s) (input to the VLC 225) of a macroblock in the current frame relative to the previous frame. A motion compensated difference is generated by subtracting the current macroblock from the best-matched macroblock in the previous frame. Such a difference is then coded by taking the DCT of the difference, quantizing the DCT coefficients, and variable length coding the quantized DCT coefficients. In the enhancement layer 250, a difference between the original frame and the reconstructed frame is generated first, by difference circuit 251. DCT (252) is applied to the difference frame and bitplane coding of the DCT coefficients is used to produce the enhancement layer bitstream. This process includes a bitplane shift (block 254), determination of a maximum (block 256) and bitplane variable length coding (block 257). The output of the enhancement encoder is the enhancement bitstream.

In the decoder of FIG. 3, the base layer bitstream is coupled to variable length decoder 305, the outputs of which are coupled to both inverse quantizer 310 and motion compensation circuit 335 (which receives the motion vectors portion fo the VLSD output). The output of inverse quantizer 310 is coupled to inverse DCT circuit 315, whose output is, in turn, an input to combiner 318. The other input to combiner 318 is the output of motion compensation circuit 335. The output of combiner 318 is coupled to clipping circuit 325 whose output is the base layer video and is also coupled to frame memory 330. The frame memory output is input to the motion compensation circuit 335. In the enhancement decoder 350, the enhancement bitstream is coupled to variable length decoder 351, whose output is coupled to bitplane shifter 353 and then inverse DCT 354. The output of IDCT 354 is one input to combiner 356, the other input to which is the decoded base layer video (which, of itself, can be an optional output). The output of combiner 356 is coupled to clipping circuit, whose output is the decoded enhancement video. As shown in the figures, the enhancement layer information is not included in the motion-compensated prediction loop.

The enhancement layer coding uses bit-plane coding of the DCT coefficient. It is possible to uses a few most significant bit-planes to reconstruct more accurate DCT coefficients and include them into the prediction loop. The question is how to do this. Most advantageously.

A video frame is divided into many blocks called macroblocks for coding. Usually, each macroblock contains 16×16 pixels of the Y component, 8×8 pixels of the U component, and 8×8 pixels of the V component. The DCT is applied to an 8×8 block. Therefore, there usually are 4 DCT blocks for the Y component and 1 DCT block for the U and V components each. When bit-plane coding is used for coding the DCT coefficients, the number of bit-planes of one macroblock may be different from that of another macroblock, depending on the value of the maximum DCT coefficient in each macroblock. When including a number of bit-planes into the prediction loop, this number is specified in the frame header. The question is what this number means relative to the number of bit-planes of each macroblock.

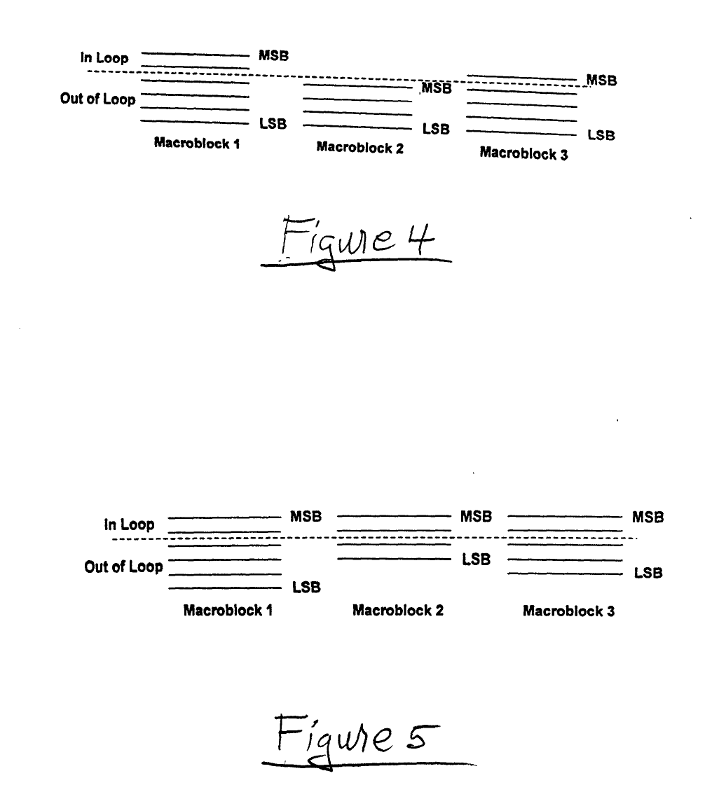

The LSB Alignment method aligns the least significant bit-planes of all the macroblocks in a frame as shown in FIG. 4.

In the example of FIG. 4, the maximum number of bit-plane in the frame is 6 and the number of bit-planes included into the loop is specified as 2. However, as shown in the FIG., macroblock 2 actually does not have any bit-planes in the loop.

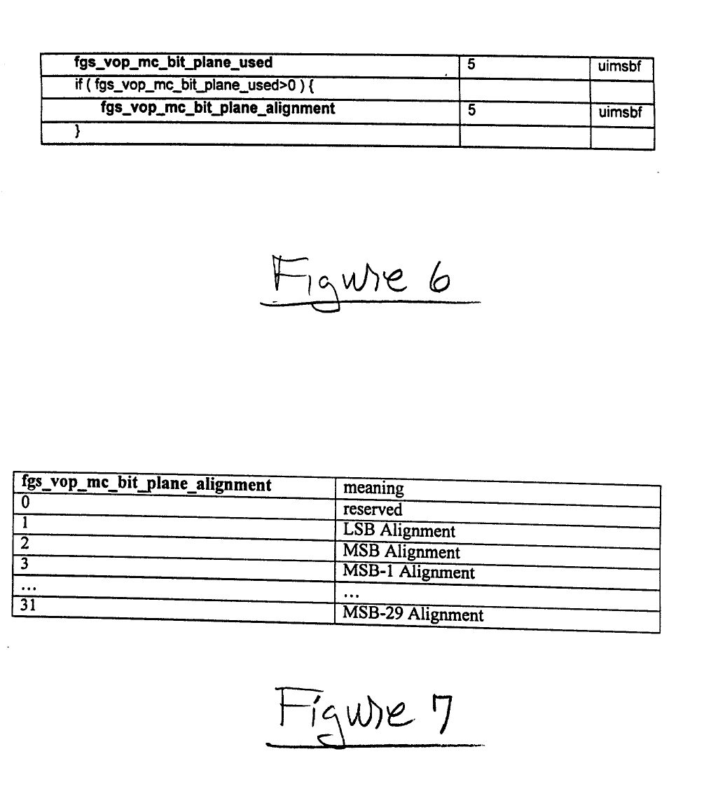

Another way to specify the relative relationship of the number of bit-planes included into the loop and the number of bit-planes of each macroblock is to use MSB Alignment, as is shown in FIG. 5. As in the LSB Alignment example, the number of bit-planes included into the loop is specified as 2. MSB Alignment ensures that all macroblocks have 2 bit-planes included in the loop.

There are different advantages and disadvantages for LSB Alignment and MSB Alignment. In LSB Alignment, some macroblocks do not have any bit-planes in the loop and thus do not help prediction quality. On the other hand, MSB Alignment puts the same number of bit-planes into the loop for all the macroblocks regardless the dynamic range of the DCT coefficients.

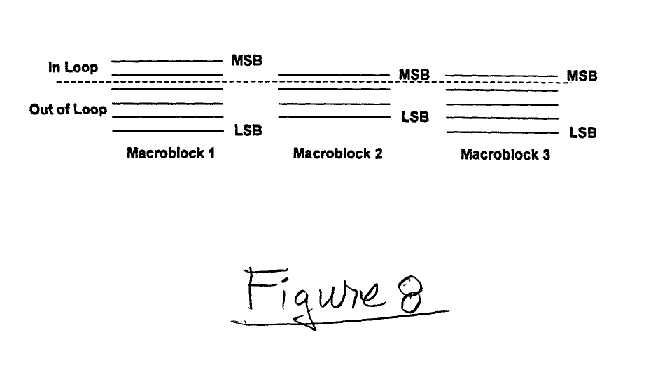

To achieve an optimal balance, in accordance with a form of the present invention, an Adaptive Alignment method is used on a frame basis. In an exemplary embodiment of the frame header, the syntax elements of the table of FIG. 6 are included, and defined as follows:

fgs_vop_mc_bit_plane_used—This parameter specifies the number of vop-bps included in the motion compensated prediction loop.

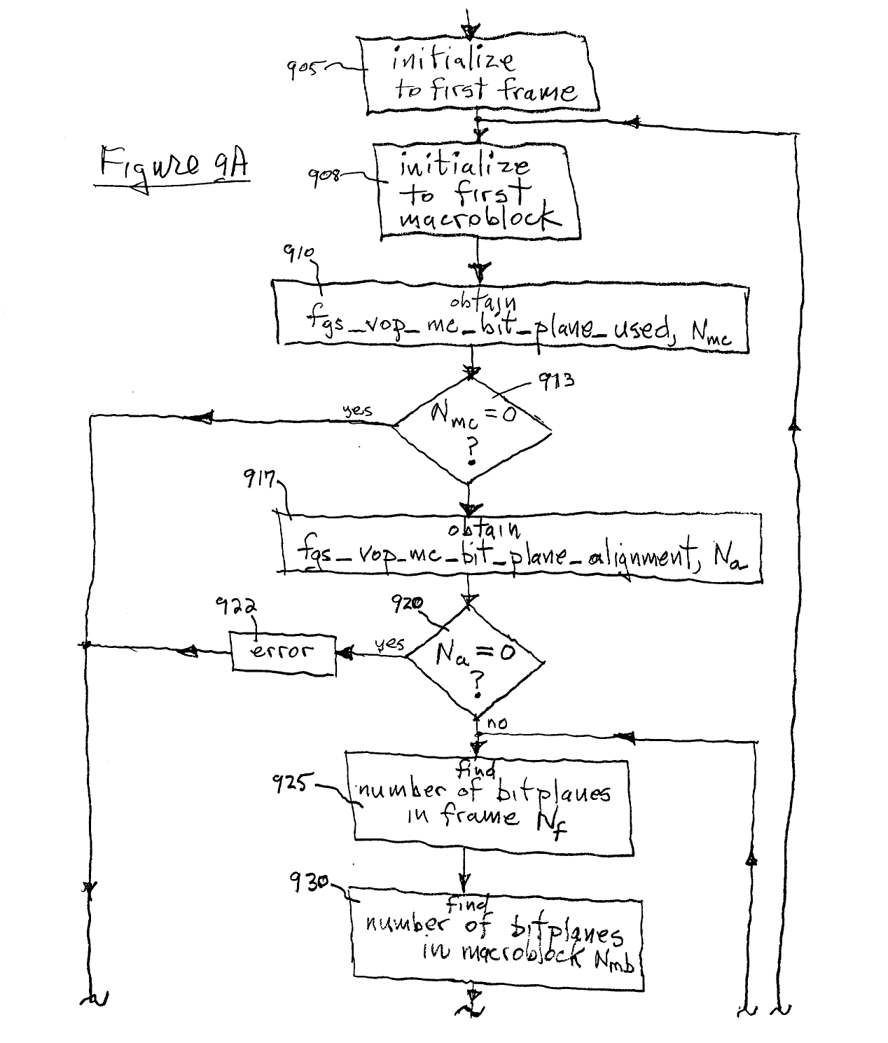

fgs_vop_mc_bit_plane_alignment—This parameter specifies how the mb-bps are aligned when counting the number of mb-bps included in the motion compensated prediction loop. The table of FIG. 7 defines the meaning of this parameter.

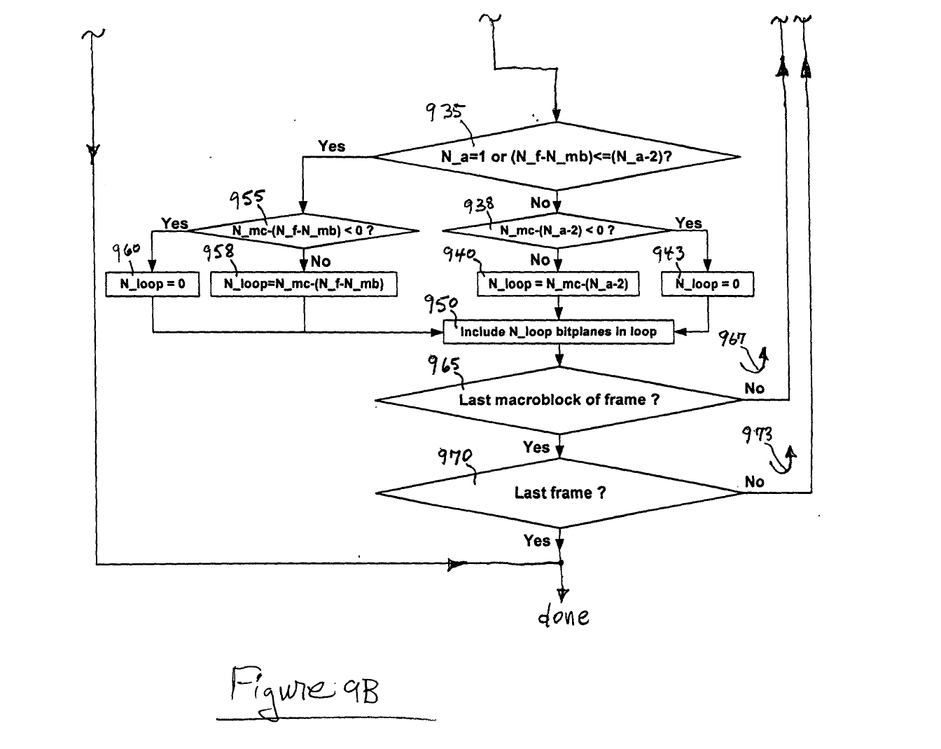

FIG. 8 shows an example of align MSB-1 of the macroblock bit-planes. Again, fgs_vop_mc_bit_plane_used is specified as 2 in the example. The MSBs of macroblock 2 and 3 are aligned with the MSB-1 vop-bp with fgs_vop_mc_bit_plane_alignment being specified as 3.

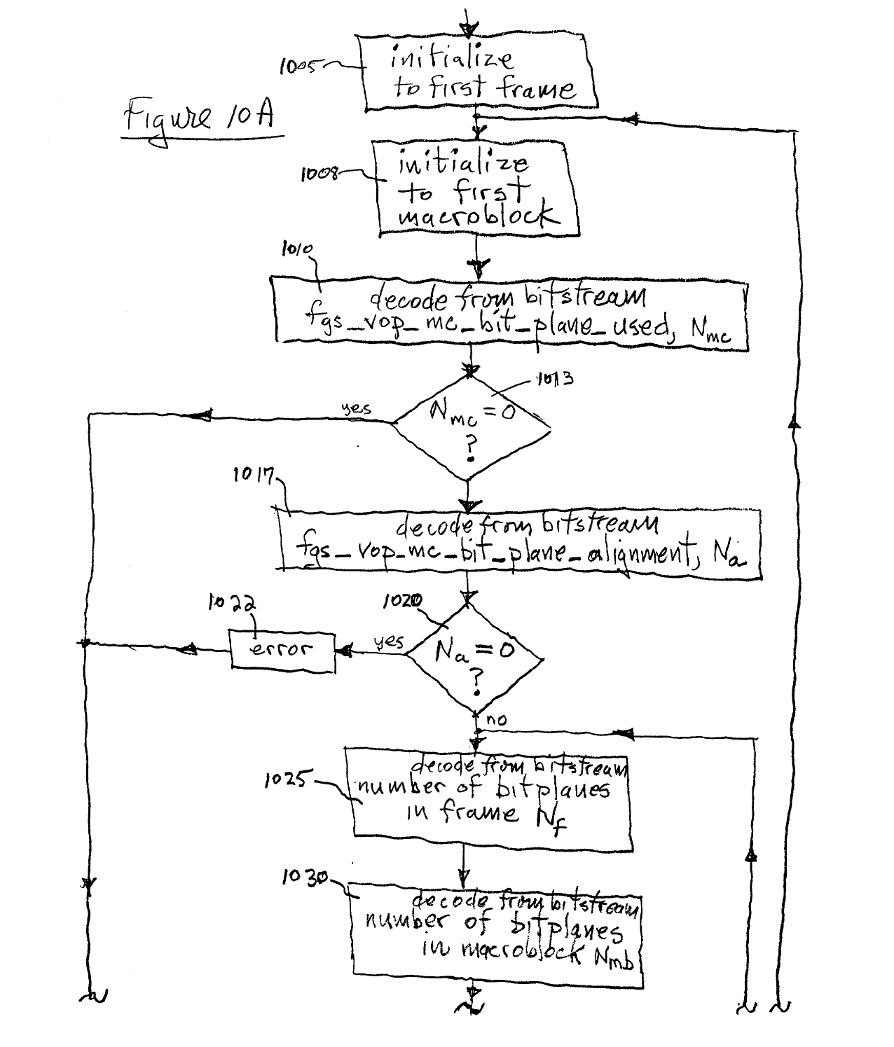

Referring to FIG. 9, there is shown a flow diagram of a routine for programming the encoder processor in accordance with an embodiment of the invention. In the flow diagram of FIG. 9, the block 905 represents initialialization to the first frame, and the block 908 represents initialization to the first macroblock of the frame. The block 910 represents obtaining fgs_vop_mc_bit_plane_used (also called N_{mc} for brevity), the number of bit planes used in the prediction loop. This can be an operator input or can be obtained or determined in any suitable manner. Determination is made (decision block 913) as to whether N_{mc} is zero, which would mean that there are no bit planes used in the prediction loop. If so, the routine is ended. If not, the block 917 is entered, this block representing the obtaining of fgs_vop_mc_bit_plane_alignment (also called Nₐ for brevity), the alignment-determining number as represented in the table of FIG. 7. In the present embodiment, the table has 31 levels of adaptive alignment (zero being reserved). The level of adaptive alignment can, for, example, be operator input, or can be obtained or determined in any suitable manner. Determination is then made (decision block 920), as to whether Nₐ is zero. If so, an error condition is indicated (see table of FIG. 7, in which 0 is reserved), and the routine is terminated. If not, the number of bitplanes in the current frame, N_f (also called N_{f}) is determined (block 925). This will normally be determined as part of the encoding process. Then, the number of bitplanes in the present macroblock is determined (block 930). This will also normally be determined as part of the encoding process.

Inquiry is then made (decision block 935) as to whether Nₐ equals 1 or (N_{f}−N_{mb}) is less than or equal to (Nₐ−2). If not, decision block 938 is entered, and determination is made as to whether Nₐ−2 is greater than N_{mc}. If not, N_loop (also called Nₗₒₒₚ), which is the number of bitplanes of the current macroblock to be included in the prediction loop, is set to N_{mc}−(Nₐ−2), as represented by the block 940. If so, Nₗₒₒₚ is set to zero. In either case, the block 950 is then entered, and, for the current macroblock, Nₗₒₒₚ bitplanes are included in the prediction loop.

Returning to the case where the inquiry of decision block 935 was answered in the affirmative, the decision block 955 is entered, and inquiry is made as to whether (N_{f}−N_{mb}) is greater than N_{mc}. If not, Nₗₒₒₚ is set equal to N_{mc}−(N_{f}−N_{mb}), as represented by the block 958. If so, Nₗₒₒₚ is set equal to zero. In either case, the block 950 is then entered, and, for the current macroblock, Nₗₒₒₚ bitplanes are included in the prediction loop.

After the described operation of block 950, decision block 965 is entered, and inquiry is made as to whether the last macroblock of the current frame has been reached. If not, the next macroblock is taken for processing (block 966), the equal to zero (block 960). In either case, block 950 is then entered, representing inclusion of Nₗₒₒₚ bitplanes in the prediction loop.

Determination is then made (decision block 965) as to whether the last macroblock of the current frame has been processed. If not the block 930 is re-entered, and the loop 967 continues until all macroblocks of the frame have been processed. Then, decision block 970 is entered, and inquiry is made as to whether the last frame to be processed has been reached. If not, the next frame is taken for processing (block 971), the block 908 is re-entered (to initialize to the first macroblock of this frame), and the loop 973 continues until all frames have been processed.

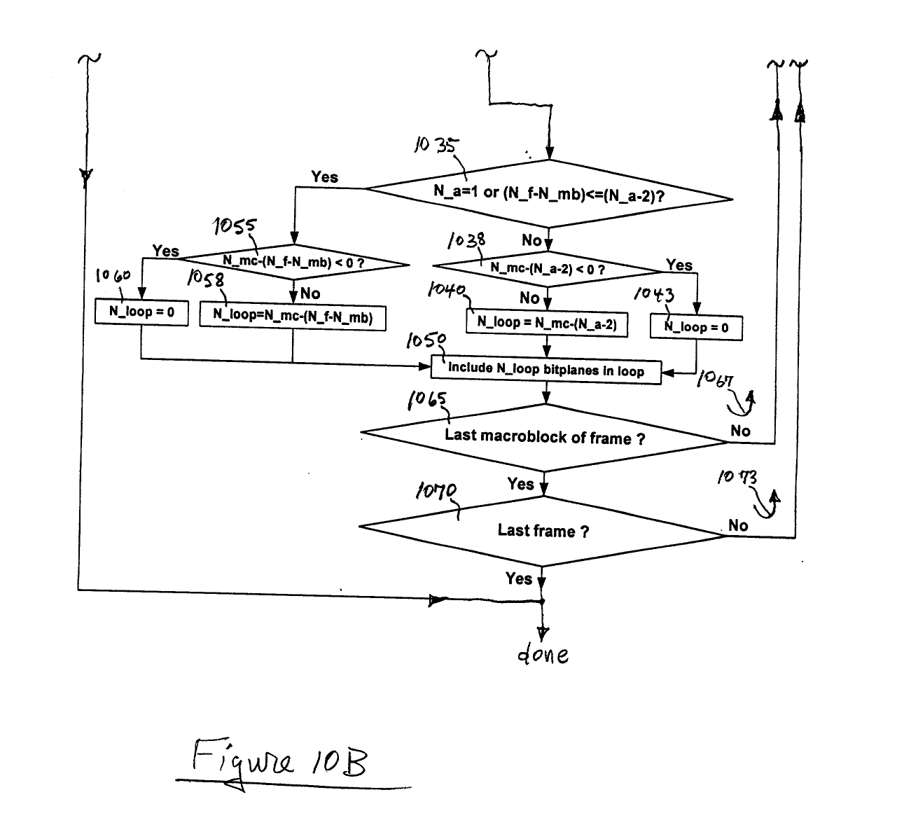

Referring to FIG. 10, there is shown a flow diagram of a routine for programming the decoder processor in accordance with an embodiment of the invention. The block 1005 represents initialialization to the first frame, and the block 1008 represents initialization to the first macroblock of the frame. The block 1010 represents obtaining, by decoding from the bitstream, fgs_vop_mc_bit_plane_used (also called N_{mc} for brevity), the number of bit planes used in the prediction loop. Determination is made (decision block 1013) as to whether N_{mc} is zero, which would mean that there are no bit planes used in the prediction loop. If so, the routine is ended. If not, the block 1017 is entered, this block representing the decoding from the bitstream of fgs_vop_mc_bit_plane_alignment (also called Nₐ for brevity), the alignment-determining number. Determination is then made (decision block 1020), as to whether Nₐ is zero. If so, an error condition is indicated (see table of FIG. 7, in which 0 is reserved), and the routine is terminated. If not, the number of bitplanes in the current frame, N_f (also called N_{f}) is decoded from the bitstream (block 1025). This will normally be determined as part of the encoding process. Then, the number of bitplanes in the present macroblock is decoded from the bitstream (block 1030).

Inquiry is then made (decision block 1035) as to whether Nₐ equals 1 or (N_{f}−N_{mb}) is less than or equal to (Nₐ−2). If not, decision block 1038 is entered, and determination is made as to whether Nₐ−2 is greater than N_{mc}. If not, N_loop (also called Nₗₒₒₚ), which is the number of bitplanes of the current macroblock to be included in the prediction loop, is set to N_{mc}−(Nₐ−2), as represented by the block 1040. If so, Nₗₒₒₚ is set to zero. In either case, the block 1050 is then entered, and, for the current macroblock, Nₗₒₒₚ bitplanes are included in the prediction loop.

Returning to the case where the inquiry of decision block 1035 was answered in the affirmative, the decision block 1055 is entered, and inquiry is made as to whether (N_{f}−N_{mb}) is greater than N_{mc}. If not, Nₗₒₒₚ is set equal to N_{mc}−(N_{f}−N_{mb}), as represented by the block 1058. If so, Nₗₒₒₚ is set equal to zero. In either case, the block 1050 is then entered, and, for the current macroblock, Nₗₒₒₚ bitplanes are included in the prediction loop.

After the described operation of block 1050, decision block 1065 is entered, and inquiry is made as to whether the last macroblock of the current frame has been reached. If not, the next macroblock is taken for processing (block 1066), the equal to zero (block 1060). In either case, block 1050 is then entered, representing inclusion of Nₗₒₒₚ bitplanes in the prediction loop.

Determination is then made (decision block 1065) as to whether the last macroblock of the current frame has been processed. If not the block 1030 is re-entered, and the loop 1067 continues until all macroblocks of the frame have been processed. Then, decision block 1070 is entered, and inquiry is made as to whether the last frame to be processed has been reached. If not, the next frame is taken for processing (block 1071), the block 1008 is re-entered (to initialize to the first macroblock of this frame), and the loop 1073 continues until all frames have been processed.

In the example of FIG. 8, N_{f} (the number of bitplanes in the frame) is 6, N_{mc} (the number of bitplanes in the prediction loop) is 2, and Nₐ (the alignment parameter of the Table of FIG. 7) is 3. For macroblock 1, n_{mb} (the number of bitplanes in the macroblock) is 6. For macroblock 2, N_{mb} is 4, and for macroblock 3 N_{mb} is 5. Stated in another notation, N_{mb1}=6, N_{mb2}=4, and N_{mb3}=5. The operation of the flow diagram of FIG. 9 can be illustrated using the example of FIG. 8. First consider macroblock 1. For this situation, the inquiry of decision block 935 is answered in the affirmative (since Nₐ−2=1 is greater than N_{f}−N_{mb1}=0), and the inquiry of decision block 955 is answered in the negative (since N_{mc}=2), is greater than N_{f}−N_{mb1}=0). Therefore, Nₗₒₒₚ, as computed in accordance with block 58, is Nₗₒₒₚ=N_{mc}−(N_{f}−N_{mb})=2−0=2, which corresponds to the 2 bitplanes in the prediction loop for macroblock 1, as shown in FIG. 8. Next, consider macroblock 2. For this situation, the inquiry of decision block 935 is answered in the negative (since N_{f}−N_{mb2}=2 is not less than or equal to Nₐ−2=1), and the inquiry of block 938 is also answered in the negative (since N_{mc}=2 is greater than Nₐ−2=1). Therefore, Nₗₒₒₚ, as computed in accordance with block 940, is Nₗₒₒₚ=N_{mc}−(Nₐ−2)=2−1=1, which corresponds to the 1 bitplane in the prediction loop for macroblock 2, as shown in FIG. 8. Next, consider the macroblock 3. For this situation, the inquiry of decision block 935 is answered in the affirmative (since N_{f}−N_{b}=1 is equal to Nₐ−2=1), and the inquiry of decision block 955 is a (since N_{mc}=2 is greater than N_{f}−N_{mb3}=1). Therefore, Nₗₒₒₚ, as computed in accordance with block 958, is Nₗₒₒₚ=N_{mc}−(Nₐ−2)=2−1=1, which corresponds to 1 bitplane in the prediction loop for macroblock 3, as shown in FIG. 8.

The invention has been described with reference to particular preferred embodiments, but variations within the spirit and scope of the invention will occur to those skilled in the art. For example, it will be understood that the same principle can be applied to the Y, U, V color components on the frame level or the DCT block level within each macroblock. Also, it will be understood that the invention is applicable for use in conjunction with plural prediction loops.

1. For use in conjunction with a video encoding/decoding technique wherein images are encoded using truncatable image-representable signals in bit plane form, the method comprising the steps of:
selecting a number of bitplanes to be used in a prediction loop; and
producing an alignment parameter in a syntax portion of an encoded bitstream that determines the alignment of bitplanes with respect to the prediction loop.

2. The method as defined by claim 1, wherein said alignment is a variable parameter.

3. The method as defined by claim 1, further comprising the step of providing a decoder for decoding said encoded bitstream.

4. The method as defined by claim 3, wherein said step of providing a decoder includes providing a decoder that is operative in response to said alignment parameter to align decoded bit planes with respect to a prediction loop.

5. The method as defined by claim 1, wherein said encoding/decoding technique comprises a fine granularity scaling encoding/decoding technique.

6. The method as defined by claim 5, wherein said fine granularity scaling encoding/decoding technique is MPFG-4 fine granularity scaling.

7. The method as defined by claim 6, further comprising repeating said selecting and producing steps for a number of frames of a video signal.

8. For use in conjunction with a video encoding/decoding technique wherein image frames are encoded using truncatable image-representable signals in bit plane form, and subsequently decoded with a decoder, a method comprising the steps of:
selecting a number of bitplanes to be used in a prediction loop; and
producing an encoded bitstream for each frame that includes an alignment parameter which determines the alignment of bitplanes with respect to the prediction loop.

9. The method as defined by claim 8, wherein said frames are frames of macroblocks, and wherein said step of producing an alignment parameter includes producing an alignment parameter for said macroblocks.

10. The method as defined by claim 9, wherein said alignment parameters are variable parameters.

11. The method as defined by claim 10, wherein said alignment parameters are in the syntax portions of said encoded bitstreams.

12. The method as defined by claim 8, further comprising the step of providing a decoder for decoding said encoded bitstream.

13. The method as defined by claim 11, further comprising the step of providing a decoder for decoding said encoded bitstream.

14. The method as defined by claim 12, wherein said step of providing a decoder includes providing a decoder that is operative in response to said alignment parameter to align decoded bit planes with respect to a prediction loop.

15. The method as defined by claim 13, wherein said step of providing a decoder includes providing a decoder that is operative in response to said alignment parameter to align decoded bit planes with respect to a prediction loop.

16. The method as defined by claim 14, wherein said encoding/decoding technique comprises a fine granularity scaling encoding/decoding technique.

17. The method as defined by claim 15, wherein said encoding/decoding technique comprises a fine granularity scaling encoding/decoding technique.

18. The method as defined by claim 16, wherein said fine granularity scaling encoding/decoding technique is MPFG-4 fine granularity scaling.

19. The method as defined by claim 17, wherein said fine granularity scaling encoding/decoding technique is MPFG-4 fine granularity scaling.

20. For use in conjunction with a video encoding/decoding technique wherein image frames are encoded using truncatable image-representable signals in bit plane form, and subsequently decoded with a decoder, an apparatus comprising:
means for selecting a number of bitplanes to be used in a prediction loop; and
means for producing an encoded bitstream for each frame that includes an alignment parameter which determines the alignment of bitplanes with respect to the prediction loop.
